(19) United States
(12) Patent Application Publication
(10) Pub. No.: US 2026/0139179 A1
(43) Pub. Date: May 21, 2026

(54) Gel Material And Multifunctional Gelpad, And Preparation Methods Thereof And Use

(71) Applicant: Yiwu Juchuang Hot Cold Technology Co., Ltd, Yiwu City (CN)

(72) Inventors: Lei KE, Yiwu City (CN); Jin Yu, Yiwu City (CN)

(21) Appl. No.: 19/022,359

(22) Filed: Jan. 15, 2025

(30) Foreign Application Priority Data
Nov. 15, 2024 (CN) 202411639683.5

(51) Int. Cl. C09K 5/10; C08F 220/58; C08K 3/22; C08K 5/053; C08K 7/26

(52) U.S. Cl. CPC C09K 5/10; C08F 220/585; C08K 3/22; C08K 5/053; C08K 7/26; C08F 2800/20; C08F 2810/20

(57) ABSTRACT

A gel material and a multifunctional gel pad, and preparation methods thereof and use are provided. The gel material includes the following raw materials, in parts by mass: 18 parts to 21 parts of 2-acrylamido-2-methylpropane sulfonic acid sodium salt (AMPS-Na), 2 parts to 4 parts of acrylic acid, 0.04 parts to 0.08 parts of a cross-linking agent, 30 parts to 40 parts of a water absorbent, 1.5 parts to 2 parts of a reinforcing agent, 0.05 parts to 0.1 parts of sodium hydroxide, 0.01 parts to 0.05 parts of a photoinitiator, 0.3 parts to 0.6 parts of a cosolvent, and 15 parts to 20 parts of water.

### CROSS REFERENCE TO RELATED APPLICATION

This patent application claims the benefit and priority of Chinese Patent Application No. 202411639683.5 filed with the China National Intellectual Property Administration on Nov. 15, 2024, and entitled with “GEL MATERIAL AND MULTIFUNCTIONAL GEL PAD, AND PREPARATION METHODS THEREOF AND USE”, the disclosure of which is incorporated by reference herein in its entirety as part of the present application.

### TECHNICAL FIELD

The present disclosure relates to the technical field of functional materials, and in particular relates to a gel material and a multifunctional gel pad, and preparation methods thereof and use.

### BACKGROUND

Super absorbent polymer (SAP), a functional polymer with a three-dimensional network structure, has strong water absorption and can be used to prepare resin pads. For example, when preparing the resin pads with SAP, polyvinyl chloride (PVC) calendered composite fabrics with upper and lower layers are generally used, which are welded by a high-frequency welding process to obtain multiple partitions, and then a cold gel obtained by water absorption and expansion of the SAP is fed into each of the partitions through a funnel filling machine. Such resin pads can be used as pet cooling pads, but the water retention effect of the SAP is poor, resulting in a short service life, which can generally only be used for one-quarter. Moreover, the cold gel obtained by the water absorption and expansion of the SAP cannot be heated for use, resulting in a single function of the resin pads.

### SUMMARY

An object of the present disclosure is to provide a gel material and a multifunctional gel pad, and preparation methods thereof and use. The gel material has strong water absorption, and the hydrogel formed after absorbing water has a desirable water retention effect. The multifunctional gel pad prepared with the gel material has a long service life, can be used repeatedly, and can be used directly, after heating, or after cooling.

To achieve the above object, the present disclosure provides the following technical solutions.

The present disclosure provides a gel material, including the following raw materials, in parts by mass: 18 parts to 21 parts of 2-acrylamido-2-methylpropane sulfonic acid sodium salt (AMPS-Na), 2 parts to 4 parts of acrylic acid, 0.04 parts to 0.08 parts of a cross-linking agent, 30 parts to 40 parts of a water absorbent, 1.5 parts to 2 parts of a reinforcing agent, 0.05 parts to 0.1 parts of sodium hydroxide, 0.01 parts to 0.05 parts of a photoinitiator, 0.3 parts to 0.6 parts of a cosolvent, and 15 parts to 20 parts of water.

In some embodiments, the cross-linking agent includes N,N-methylenebisacrylamide (MBAA); the water absorbent includes one or more selected from the group consisting of glycerol and propylene glycol; the reinforcing agent includes fumed silica; the photoinitiator includes one or more selected from the group consisting of a photoinitiator 184 (1-hydroxycyclohexyl phenyl ketone) and a photoinitiator 1173 (2-hydroxy-2-methyl-1-phenyl-1-propanone); and the cosolvent includes isopropyl alcohol (IPA).

The present disclosure further provides a method for preparing the gel material as described in the above technical solutions, including: mixing the raw materials, subjecting a resulting mixture to polymerization, and then drying to obtain the gel material.

The present disclosure further provides a multifunctional gel pad, including multiple connected sealing members, where each of the sealing members is formed by enclosing a first composite and a second composite, and each of the sealing members is filled with the gel material as described in the above technical solutions or a gel material prepared by the method as described in the above technical solutions; and where the first composite includes a waterproof fabric and a first polyethylene-vinyl acetate (PEVA) film that are laminated, the second composite includes a breathable fabric and a second PEVA film that are laminated, the first PEVA film and the second PEVA film each are arranged on an inner side of each of the sealing members, and the second PEVA film is provided with multiple micropores.

In some embodiments, each of the micropores independently has a pore diameter of less than 1 mm, and two adjacent micropores have a separation distance of 4 mm to 6 mm.

In some embodiments, the sealing members each have a regular shape and/or an irregular shape; and each of the sealing members has a lateral dimension and a vertical dimension both less than or equal to 10 cm.

In some embodiments, the gel material in each of the sealing members has a filling amount of 0.2 g to 1 g.

The present disclosure further provides a method for preparing the multifunctional gel pad as described in the above technical solutions, including:
providing the first composite and the second composite, where the first composite is compounded by the waterproof fabric and the first PEVA film that are laminated, with a first hot melt adhesive, the second composite is compounded by the breathable fabric and the second PEVA film that are laminated, with a second hot melt adhesive, and the second PEVA film is provided with multiple micropores; and
stacking the first composite and the second composite such that the first PEVA film is close to the second PEVA film, placing the gel material between the first PEVA film and the second PEVA film, then subjecting a resulting product to heat sealing treatment, bagging the first composite and the second composite to form the connected multiple sealing members, and filling each of the sealing members with the gel material, to obtain the multifunctional gel pad.

The present disclosure further provides use of the multifunctional gel pad as described in the above technical solutions or a multifunctional gel pad prepared by the method as described in the above technical solutions in heat preservation.

In some embodiments, the heat preservation is conducted by a process including: immersing the multifunctional gel pad in water to obtain a hydrogel pad; and using the hydrogel pad directly; alternatively, heating or cooling the hydrogel pad before using.

Beneficial effects: in the present disclosure, the gel material includes the following raw materials, in parts by mass: 18 parts to 21 parts of 2-acrylamido-2-methylpropane sulfonic acid sodium salt (AMPS-Na), 2 parts to 4 parts of acrylic acid, 0.04 parts to 0.08 parts of a cross-linking agent, 30 parts to 40 parts of a water absorbent, 1.5 parts to 2 parts of a reinforcing agent, 0.05 parts to 0.1 parts of sodium hydroxide, 0.01 parts to 0.05 parts of a photoinitiator, 0.3 parts to 0.6 parts of a cosolvent, and 15 parts to 20 parts of water. The gel material has strong water absorption, and the hydrogel formed after absorbing water has a desirable water retention effect. The multifunctional gel pad prepared with the gel material has a long service life, can be used repeatedly, and can be used directly, after heating, or after cooling. Specifically, when the multifunctional gel pad is prepared with the gel material, the gel material is directly filled into the sealing members of the multifunctional gel pad. Before use, the multifunctional gel pad is immersed in water to allow the gel material to absorb water and form a hydrogel, and can then be used directly, after heating, or after cooling. After use, the multifunctional gel pad can be placed outdoors to allow the water to evaporate and the hydrogel to return to the original gel material, making the product lighter and more convenient to carry outside or store at home.

### DETAILED DESCRIPTION OF THE EMBODIMENTS

The present disclosure provides a gel material, including the following raw materials, in parts by mass:

18 parts to 21 parts of 2-acrylamido-2-methylpropane sulfonic acid sodium salt (AMPS-Na), 2 parts to 4 parts of acrylic acid, 0.04 parts to 0.08 parts of a cross-linking agent, 30 parts to 40 parts of a water absorbent, 1.5 parts to 2 parts of a reinforcing agent, 0.05 parts to 0.1 parts of sodium hydroxide, 0.01 parts to 0.05 parts of a photoinitiator, 0.3 parts to 0.6 parts of a cosolvent, and 15 parts to 20 parts of water.

In the present disclosure, unless otherwise specified, the raw materials used are all commercially-available commodities well known to those skilled in the art or prepared by methods well known to those skilled in the art.

In the present disclosure, the raw materials of the gel material include 18 parts to 21 parts, specifically 18 parts, 18.5 parts, 19 parts, 19.5 parts, 20 parts, 20.5 parts, or 21 parts of the AMPS-Na. In the present disclosure, the AMPS-Na as a monomer is a multifunctional water-soluble anionic surfactant, which is compounded with the acrylic acid, the water absorbent, and the reinforcing agent to prepare the gel material. The gel material has desirable water absorption, and the hydrogel formed after absorbing water has high water retention effect, excellent low-temperature flexibility, and permanent compression resilience.

In the present disclosure, based on the parts by mass of the AMPS-Na, the raw materials of the gel material include 2 parts to 4 parts by mass, specifically 2 parts, 2.5 parts, 3 parts, 3.5 parts, or 4 parts by mass of the acrylic acid. In the present disclosure, the acrylic acid can copolymerize with the AMPS-Na when AMPS-Na is polymerized, while the water absorbent and the reinforcing agent are compounded to obtain a gel material with desirable water absorption. The hydrogel formed by the gel material after absorbing water has high water retention effect, excellent low-temperature flexibility, and permanent compression resilience.

In the present disclosure, based on the parts by mass of the AMPS-Na, the raw materials of the gel material include 0.04 parts to 0.08 parts by mass, specifically 0.04 parts, 0.045 parts, 0.05 parts, 0.055 parts, 0.06 parts, 0.065 parts, 0.07 parts, 0.075 parts, or 0.08 parts by mass of the cross-linking agent. As an embodiment of the present disclosure, the cross-linking agent include MBAA.

In the present disclosure, based on the parts by mass of the AMPS-Na, the raw materials of the gel material include 30 parts to 40 parts by mass, specifically 30 parts, 31 parts, 32 parts, 33 parts, 34 parts, 35 parts, 36 parts, 37 parts, 38 parts, 39 parts, or 40 parts by mass of the water absorbent. As an embodiment of the present disclosure, the water absorbent may include one or more selected from the group consisting of glycerol and propylene glycol, and specifically may be the glycerol. In some embodiments of the present disclosure, the above type of water absorbent used is beneficial to improving the water absorption of the gel material, such that the gel material can absorb more water and maintain a better moisturizing effect, and can also increase the softness and elasticity of the hydrogel.

In the present disclosure, based on the parts by mass of the AMPS-Na, the raw materials of the gel material include 1.5 parts to 2 parts by mass, specifically 1.5 parts, 1.6 parts, 1.7 parts, 1.8 parts, 1.9 parts, or 2 parts by mass of the reinforcing agent. As an embodiment of the present disclosure, the reinforcing agent includes fumed silica. In some embodiments of the present disclosure, the above type of reinforcing agent used can form a reversible three-dimensional network structure in the hydrogel by generating a hydrogen bond bridging effect, thereby giving the hydrogel the most suitable rheological effect. This not only helps to control the rheological properties of the hydrogel, but also prevents its sedimentation and sagging, thereby further improving the mechanical properties of the hydrogel.

In the present disclosure, based on the parts by mass of the AMPS-Na, the raw materials of the gel material include 0.05 parts to 0.1 parts by mass, specifically 0.05 parts, 0.06 parts, 0.07 parts, 0.08 parts, 0.09 parts, or 0.1 parts by mass of the sodium hydroxide.

In the present disclosure, based on the parts by mass of the AMPS-Na, the raw materials of the gel material include 0.01 parts to 0.05 parts by mass, specifically 0.01 parts, 0.015 parts, 0.02 parts, 0.025 parts, 0.03 parts, 0.035 parts, 0.04 parts, 0.045 parts, or 0.05 parts by mass of the photoinitiator. As an embodiment of the present disclosure, the photoinitiator includes one or more selected from the group consisting of a photoinitiator 184 (1-hydroxycyclohexyl phenyl ketone) and a photoinitiator 1173 (2-hydroxy-2-methyl-1-phenyl-1-propanone), and specifically may be the photoinitiator 184. In some embodiments of the present disclosure, the above type of photoinitiator used can initiate polymerization, cross-linking, and curing of the AMPS-Na.

In the present disclosure, based on the parts by mass of the AMPS-Na, the raw materials of the gel material include 0.3 parts to 0.6 parts by mass, specifically 0.3 parts, 0.35 parts, 0.4 parts, 0.45 parts, 0.5 parts, 0.55 parts, or 0.6 parts by mass of the cosolvent. As an embodiment of the present disclosure, the cosolvent includes IPA. In some embodiments of the present disclosure, the above type of cosolvent used can help dissolve or disperse the raw materials such as the photoinitiator, thereby ensuring smooth preparation of the gel material.

In the present disclosure, based on the parts by mass of the AMPS-Na, the raw materials of the gel material include 15 parts to 20 parts by mass, specifically 15 parts, 16 parts, 17 parts, 18 parts, 19 parts, or 20 parts by mass of water.

The present disclosure further provides a method for preparing the gel material as described in the above technical solutions, including the following steps:
mixing the raw materials, subjecting a resulting mixture to polymerization, and then drying to obtain the gel material.

As an embodiment of the present disclosure, the mixing of the raw materials may be conducted by a process including: mixing an AMPS-Na aqueous solution and a cross-linking agent aqueous solution to obtain a first mixture; mixing the first mixture and acrylic acid to obtain a second mixture; mixing the second mixture, glycerol and a fumed silica to obtain a third mixture; mixing the third mixture and a sodium hydroxide aqueous solution to obtain a fourth mixture; and mixing the fourth mixture and a photoinitiator solution. As an embodiment of the present disclosure, the AMPS-Na aqueous solution has a mass concentration of 50% to 60%, specifically 50%, 53%, 55%, 58%, or 60%; a mass ratio of the cross-linking agent to water in the cross-linking agent aqueous solution may be 0.04:2.2 to 0.08:2.2, specifically 0.045:2.2; the sodium hydroxide aqueous solution has a concentration of 45 wt % to 55 wt %, specifically 50 wt %. In some embodiments of the present disclosure, a total amount of water in the AMPS-Na aqueous solution, the cross-linking agent aqueous solution, and the sodium hydroxide aqueous solution is a total amount of water used to prepare the gel material. As an embodiment of the present disclosure, the photoinitiator solution is obtained by mixing the photoinitiator and the cosolvent.

In the present disclosure, after mixing the raw materials, a resulting mixture is subjected to polymerization, and then dried to obtain the gel material. As an embodiment of the present disclosure, the polymerization is conducted under a condition of UV irradiation; the polymerization is conducted for 5 s to 30 s, specifically 10 s to 12 s; the UV irradiation may has a wavelength of 250 nm to 420 nm, specifically 365 nm. As an embodiment of the present disclosure, the polymerization is conducted by a process including: placing a mold having a square flat pit on a conveyor belt, spraying a release agent evenly on an inner surface of the pit, then pouring the mixture into the pit, and starting the conveyor belt; during operation of the conveyor belt, placing 3 to 5 UV curing devices in parallel above the conveyor belt, subjecting the mixture to polymerization after UV irradiation to form a solid hydrogel block; after passing the hydrogel block through the UV curing devices, placing one cold air blower above the conveyor belt, with an air outlet facing the conveyor belt, and cooling the mold and the hydrogel block to room temperature by the cold air blower; after passing the hydrogel block through the cold air blower, attaching a layer of PET film to one surface of the hydrogel block, then turning the mold upside down, taking out the hydrogel block, and then attaching another layer of PET film to the other surface of the hydrogel block for standby use.

As an embodiment of the present disclosure, after the polymerization, the method further includes crushing a resulting product, specifically the crushing and the drying may be conducted simultaneously. In some embodiments of the present disclosure, the crushing and the drying are conducted simultaneously using a drying-crushing integrated device. There is no specific limitation on the specific operating conditions of the crushing and the drying, and the operating conditions well known to those skilled in the art may be used. In the present disclosure, after the crushing and the drying, the obtained gel material is specifically gel particles.

The present disclosure further provides a multifunctional gel pad, including multiple connected sealing members, where each of the sealing members is formed by enclosing a first composite and a second composite, and each of the sealing members is filled with the gel material as described in the above technical solutions or a gel material prepared by the method as described in the above technical solutions; and the first composite includes a waterproof fabric and a first PEVA film that are laminated, the second composite includes a breathable fabric and a second PEVA film that are laminated, the first PEVA film and the second PEVA film each are arranged on an inner side of the sealing member, and the second PEVA film is provided with multiple micropores.

In the production of the resin pads with SAP in related technologies, PVC calendered composite fabrics with upper and lower layers are generally used, which are welded by a high-frequency welding process to obtain multiple partitions, and then a cold gel obtained by water absorption and expansion of the SAP is fed into each of the partitions through a funnel filling machine. The resin pad is heavy overall, has a large packaging volume and high transportation costs. In addition, the PVC film is a breathable material, the water in the cold gel evaporates through the PVC film and easily forms condensed water on the surface of the resin pad. The condensed water that remains on the surface of the cloth for a long time can breed mold, causing the product to become mouldy. Moreover, the resin pad has a short service life and can generally only be used for one-quarter. The multifunctional gel pad provided by the present disclosure uses a PEVA film that is degradable, which is more conducive to ensuring that environmental protection requirements are met compared to PVC film; the micropores are set to facilitate water to enter the sealing member through the micropores when using the multifunctional gel pad, such that water can contact the gel material, and the gel material expands to form a hydrogel after absorbing water; in addition, the multifunctional gel pad provided by the present disclosure is light in weight and easy to carry, can be reused, has a long service life, is easy to store, is not easy to mold, and is healthy and environmentally friendly. The multifunctional gel pad of the present disclosure will be described in detail below.

As an embodiment of the present disclosure, the first composite is compounded by the waterproof fabric and the first PEVA film that are laminated, with a hot melt adhesive, the second composite is compounded by the breathable fabric and the second PEVA film that are laminated, with a hot melt adhesive, and micropores are pre-punched on the second PEVA film.

As an embodiment of the present disclosure, the micropores on the second PEVA film are distributed in an array; each of the micropores independently has a pore diameter of less than 1 mm, such as 0.5 mm to 0.8 mm, specifically 0.5 mm, 0.6 mm, 0.7 mm, or 0.8 mm; and two adjacent micropores have a separation distance of 4 mm to 6 mm, specifically 4 mm, 5 mm, or 6 mm. As an embodiment of the present disclosure, the first PEVA film is not provided with the micropores. The pore size and separation distance of the micropores in the example of the present disclosure are limited to the above ranges. On the one hand, it can ensure that when the multifunctional gel pad is used, a large amount of water enters the sealing member within 3 min to 5 min, which is conducive to the gel material absorbing water and completing expansion as soon as possible; on the other hand, the pore size is not too large, which prevents the gel material from seeping out through the micropores after absorbing water and expanding.

As an embodiment of the present disclosure, the breathable fabric includes a conventional textile fabric such as polyester taffeta, polyester pongee, nylon taffeta, and Oxford cloth.

As an embodiment of the present disclosure, the waterproof fabric is a breathable fabric after waterproof treatment, that is, the waterproof fabric specifically may be a conventional textile fabric after waterproof treatment, such as waterproofed polyester taffeta, waterproofed polyester pongee, waterproofed nylon taffeta, and waterproofed Oxford cloth. There is no special limitation on the specific method of the waterproof treatment, and the method known to those skilled in the art can be used.

As an embodiment of the present disclosure, the sealing members each have a regular shape (such as square and/or circular) and/or an irregular shape; each of the sealing members has a lateral dimension and a vertical dimension both less than or equal to 10 cm, such as 3 cm to 8 cm, and specifically 3 cm, 4 cm, 5 cm, 6 cm, 7 cm, or 8 cm. As an embodiment of the present disclosure, the gel material in each of the sealing members has a filling amount of 0.2 g to 1 g, specifically 0.2 g, 0.3 g, 0.4 g, 0.5 g, 0.6 g, 0.7 g, 0.8 g, 0.9 g, or 1 g. In the production of the resin pads with SAP in related technologies, the partitions in the resin pad are generally long strips, and the cold gel formed after SAP absorbs water has poor elasticity. When the resin pad is used as a pet cooling pad, the cold gel (obtained by SAP absorbing water) filled in the partitions is squeezed and easily flows to two ends of each partition, resulting in poor pet cooling effect. The gel material in the example of the present disclosure has high elasticity after absorbing water, and the lateral and vertical dimensions of the sealing member are controlled to be less than or equal to 10 cm. Meanwhile, a filling amount of the gel material in each sealing member is controlled to be 0.2 g to 1 g, such that the hydrogel obtained after the gel material absorbs water fills the entire sealing member. In this way, the hydrogel is not easy to flow during use, ensuring the desirable thermal insulation effect.

As an embodiment of the present disclosure, a fixing component with a fixing hole can be provided on an edge of the multifunctional gel pad, and the multifunctional gel pad is provided with a fixing belt adapted to the fixing hole. The fixing belt through the fixing hole can realize fixing of the multifunctional gel pad at the target position, which is convenient for use.

The present disclosure further provides a method for preparing the multifunctional gel pad, including the following steps:
providing the first composite and the second composite, where the first composite is compounded by the waterproof fabric and the first PEVA film that are laminated, with a first hot melt adhesive, the second composite is compounded by the breathable fabric and the second PEVA film that are laminated, with a second hot melt adhesive, and the second PEVA film is provided with multiple micropores; and
stacking the first composite and the second composite such that the first PEVA film is close to the second PEVA film, placing the gel material between the first PEVA film and the second PEVA film, then subjecting a resulting product to heat sealing treatment, bagging the first composite and the second composite to form the connected multiple sealing members, and filling each of the sealing members with the gel material, to obtain the multifunctional gel pad.

The present disclosure further provides use of the multifunctional gel pad as described in the above technical solutions or a multifunctional gel pad prepared by the method as described in the above technical solutions in heat preservation. As an embodiment of the present disclosure, the heat preservation may include keeping warm or keeping cold; specifically, the heat preservation may be conducted by a process including:
immersing the multifunctional gel pad in water to obtain a hydrogel pad; and
using the hydrogel pad directly; alternatively, heating or cooling the hydrogel pad before using.

In the present disclosure, the multifunctional gel pad is immersed in water to obtain a hydrogel pad. As an embodiment of the present disclosure, the immersing can be conducted for 3 min to 5 min, specifically 3 min, 4 min, or 5 min; during the immersing, water enters each of the sealing members through the micropores, and the gel material immediately absorbs the water and rapidly expands to 3 to 5 times its own weight to form the hydrogel. The hydrogel has a desirable elasticity and fills each of the sealing members, thus does not flow during use.

In the present disclosure, after obtaining the hydrogel pad, the hydrogel pad can be used directly, for example, the hydrogel pad can be directly placed on the ground as a pet cooling pad for cooling the pet in summer.

In the present disclosure, after obtaining the hydrogel pad, the hydrogel pad can be heated or cooled before using. In some embodiments of the present disclosure, the heating may be conducted by microwave heating, and the microwave heating may be conducted in a microwave oven with an output power of 600 W to 900 W, specifically 600 W, 700 W, 800 W, or 900 W; the microwave heating may be conducted for 1 min to 3 min, specifically 1 min, 2 min, or 3 min. Specifically, the hydrogel pad may be placed in the microwave oven for heating; and a heated hydrogel pad may be used for hot compress or for heating, such as being directly placed in a pet nest for heating the pet in winter. In some embodiments of the present disclosure, the cooling can be conducted at a temperature of −20° C. to 10° C., specifically −20° C., −18° C., −10° C., 0° C., or 10° C.; the cooling can be conducted for 1 h to 4 h, specifically 1 h, 1.5 h, 2 h, 3 h, or 4 h. In some embodiments of the present disclosure, the hydrogel pad is placed in a refrigerator for cooling; and a cooled hydrogel pad can be used for cold compress or for cooling.

As an embodiment of the present disclosure, the hydrogel pad can be placed outdoors after use. The water in the hydrogel in the sealing member gradually evaporates under the sun or wind, and finally the hydrogel returns to the original gel material (it can be restored to the original gel material in about 10 d to 15 d, which is related to the outdoor temperature and wind volume), making the product lighter and convenient to carry when going out or store at home.

The technical solutions of the present disclosure will be clearly and completely described below with reference to the examples of the present disclosure. Apparently, the described examples are merely a part rather than all of the examples of the present disclosure. All other examples obtained by those skilled in the art based on the examples of the present disclosure without creative efforts shall fall within the scope of the present disclosure.

### Example 1

(1) A cross-linking agent aqueous solution was added to 34 kg of an AMPS-Na aqueous solution with a mass fraction of 58% under stirring to obtain a first mixture; where the cross-linking agent aqueous solution was obtained by mixing 45 g of MBAA and 2.2 kg of a filtered water. 2 kg of acrylic acid was added to the first mixture to obtain a second mixture. 32.6 kg of glycerol and 1.8 kg of fumed silica were added to the second mixture to obtain a third mixture. A sodium hydroxide aqueous solution was added to the third mixture to obtain a fourth mixture; where the sodium hydroxide aqueous solution was obtained by mixing 0.05 kg of sodium hydroxide solid and 0.05 kg of a filtered water. A photoinitiator solution was added to the fourth mixture to obtain a fifth mixture; where the photoinitiator solution was obtained by mixing 14 g of photoinitiator 184 and 0.45 kg of IPA.

(2) A mold having a square flat pit was placed on a conveyor belt, a release agent was sprayed evenly on an inner surface of the pit, then the fifth mixture was poured into the pit, and the conveyor belt was turned on. During operation of the conveyor belt, 5 UV curing devices were placed in parallel above the conveyor belt, and the fifth mixture was subjected to UV-irradiation (UV wavelength was 365 nm, and irradiation time was 12 s) to form a solid hydrogel block.

After the hydrogel block passed through the UV curing devices, one cold air blower was placed above the conveyor belt, with an air outlet facing the conveyor belt, and the mold and the hydrogel block were cooled to room temperature by the cold air blower. After the hydrogel block passed through the cold air blower, a layer of PET film was attached to one surface of the hydrogel block, then the mold was turned upside down, the hydrogel block was taken out, and then another layer of PET film was attached to the other surface of the hydrogel block for standby use.

The hydrogel block was dried and crushed by a drying-crushing integrated device to obtain gel particles.

### Test Example 1

After fully absorbing water, the hydrogel block in Example 1 was placed in a constant-temperature drying oven, and conducted heat treatment at 70° C. The hydrogel block was taken out and weighed at the same time every day to test the water retention performance of the hydrogel block, which was compared with the SAP (purchased from Jinan Huadi Company, with a product model of 760) after fully absorbing water.

Table 1 shows the test results of the water retention performance of the hydrogel block in Example 1 and SAP. Table 1 shows that the hydrogel block prepared in Example 1 of the present disclosure has excellent water retention.

TABLE 1
Test results of water retention performance
of hydrogel block in Example 1 and SAP

| | Sample weight (g) | |
|---|---|---|
| Test time | Hydrogel block in Example 1 | SAP |
| September 3 | 100 | 100 |
| (initial weight after full absorbing water) | | |
| September 4 | 88.4 | 74.5 |
| September 5 | 81.7 | 50.6 |
| September 6 | 78.0 | 31.4 |
| September 7 | 72.1 | 11.9 |
| September 8 | 70.0 | 3.0 |
| September 9 | 68.0 | 1.8 |
| September 10 | 66.8 | 1.0 |

### Test Example 2

The hydrogel block prepared in Example 1 was subjected to a low-temperature flexibility test and a permanent compression resilience test, and compared with super absorbent polymer SAP (purchased from Jinan Huadi Company, with a product model of 760).

Table 2 shows the performance test results of the hydrogel block prepared in Example 1, and Table 3 shows the performance test results of SAP. The results show that the hydrogel block prepared in Example 1 has excellent low-temperature flexibility and permanent compression resilience.

TABLE 2
Performance test results of hydrogel block prepared in Example 1

| Test item | | Test method | Test conditions | | Test results |
|---|---|---|---|---|---|
| Low-temperature | Appearance | GB/T | Φ = 20 mm, t = −12° C. | | The sample is |
| flexibility | After recovery | 328.14-2007 | | | normally |
| | | | | | transparent and |
| | | | | | soft |
| Permanent | Sample | GB/T | Sample | 23.40 mm | 72.7 |
| compression | thickness | 7759.1-2015 | thickness | | |
| resilience (%) | Compression | | Compression | 1 h | |
| | time | | time | | |
| | Compression | | Compression | 17.64 mm | |
| | thickness | | thickness | | |
| | Recovery | | Recovery | 21.83 mm | |
| | thickness | | thickness | | |

TABLE 3
Performance test results of SAP

| Test item | | Test method | Test conditions | | Test results |
|---|---|---|---|---|---|
| Low-temperature | Appearance | GB/T | Φ = 20 mm, t = −12° C. | | The sample is |
| flexibility | After recovery | 328.14-2007 | | | normally |
| | | | | | transparent and |
| | | | | | soft |
| Permanent | Sample | GB/T | Sample | 22.00 mm | 6.0 |
| compression | thickness | 7759.1-2015 | thickness | | |
| resilience (%) | Compression | | Compression | 1 h | |
| | time | | time | | |
| | Compression | | Compression | 16.55 mm | |
| | thickness | | thickness | | |
| | Recovery | | Recovery | 16.89 mm | |
| | thickness | | thickness | | |

### Example 2

A gel pad was prepared using the gel particles prepared in Example 1, including the following specific steps:

A first composite and a second composite were provided, the first composite was compounded by a waterproof fabric and a first PEVA film which were laminated, with a hot melt adhesive, and the second composite was compounded by a breathable fabric and a second PEVA film which were laminated, with a hot melt adhesive; where the waterproof fabric was waterproofed Oxford cloth, the breathable fabric was Oxford cloth; the second PEVA film was pre-set with micropores distributed in an array, the micropores had a pore size of 0.8 mm, and two adjacent micropores had a separation distance of 5 mm, and the first PEVA film was not set with the micropores.

The first composite and the second composite were stacked such that the first PEVA film was close to the second PEVA film, the gel particles were placed between the first PEVA film and the second PEVA film, and then a resulting product was subjected to heat sealing treatment by an automated heat-sealing integrated device, the first composite and the second composite were bagged to form connected multiple sealing members, and each of the sealing members was filled with the gel particles; where the sealing member was square in shape, lateral and vertical dimensions of each of the sealing members were both 5.5 mm, and each of the sealing members in the gel particles had a filling amount of 0.3 g.

Further, a fixing component with a fixing hole could be provided on an edge of the gel pad and the gel pad was provided with a fixing belt adapted to the fixing hole. The fixing belt passed through the fixing hole could realize fixing of the gel pad at a target position, which was convenient for use.

### Use Example 1

A method for using the gel pad prepared in Example 2 included the following steps.

The gel pad was placed in water for 4 min, and water entered each of the sealing members through micropores. The gel particles immediately absorbed the water and quickly expanded to 3 to 5 times their own weight. After the gel particles fully absorbed water, they formed hydrogels, that is, each of the sealing members was filled with the hydrogels (the hydrogels had a certain elasticity and the filling amount is appropriate, such that the hydrogels in the sealing member did not flow), and then the sealing members were taken out of the water and the surface was wiped dry to obtain a hydrogel pad.

The hydrogel pad could be placed directly on the ground to cool pets in summer.

Alternatively, the hydrogel pad was placed in a microwave oven and heated at an output power of 700 W for 2 min, and then taken out of the microwave oven and used for hot compress or heating, such as being directly placed in a pet bed to heat pets in winter.

Alternatively, the hydrogel pad was placed in a refrigerator and frozen at −18° C. for 1.5 h, and then taken out of the refrigerator for use as a cold compress or for cooling.

When not in use, the hydrogel pad was placed outdoors, and the water in the hydrogel in the sealing member was gradually evaporated under the sun or wind and finally the hydrogel restored to the original gel particles, making the product lighter and convenient to carry when going out or store at home.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A gel material, comprising the following raw materials, in parts by mass:
18 parts to 21 parts of 2-acrylamido-2-methylpropane sulfonic acid sodium salt (AMPS-Na), 2 parts to 4 parts of acrylic acid, 0.04 parts to 0.08 parts of a cross-linking agent, 30 parts to 40 parts of a water absorbent, 1.5 parts to 2 parts of a reinforcing agent, 0.05 parts to 0.1 parts of sodium hydroxide, 0.01 parts to 0.05 parts of a photoinitiator, 0.3 parts to 0.6 parts of a cosolvent, and 15 parts to 20 parts of water.

2. The gel material of claim 1, wherein the cross-linking agent comprises N,N-methylenebisacrylamide (MBAA);
the water absorbent comprises one or more selected from the group consisting of glycerol and propylene glycol; the reinforcing agent comprises fumed silica;
the photoinitiator comprises one or more selected from the group consisting of a photoinitiator 184 (1-hydroxycyclohexyl phenyl ketone) and a photoinitiator 1173 (2-hydroxy-2-methyl-1-phenyl-1-propanone); and
the cosolvent comprises isopropyl alcohol (IPA).

3. A method for preparing the gel material of claim 1, comprising:
mixing the raw materials, subjecting a resulting mixture to polymerization, and then drying to obtain the gel material.

4. A multifunctional gel pad, comprising multiple connected sealing members, wherein each of the sealing members is formed by enclosing a first composite and a second composite, and each of the sealing members is filled with the gel material of claim 1; and
wherein the first composite comprises a waterproof fabric and a first polyethylene-vinyl acetate (PEVA) film that are laminated, the second composite comprises a breathable fabric and a second PEVA film that are laminated, the first PEVA film and the second PEVA film each are arranged on an inner side of each of the sealing members, and the second PEVA film is provided with multiple micropores.

5. The multifunctional gel pad of claim 4, wherein each of the micropores independently has a pore diameter of less than 1 mm, and two adjacent micropores have a separation distance of 4 mm to 6 mm.

6. The multifunctional gel pad of claim 4, wherein the sealing members each have a regular shape and/or an irregular shape; and each of the sealing members has a lateral dimension and a vertical dimension both less than or equal to 10 cm.

7. The multifunctional gel pad of claim 6, wherein the gel material in each of the sealing members has a filling amount of 0.2 g to 1 g.

8. A method for preparing the multifunctional gel pad of claim 4, comprising:
providing the first composite and the second composite, wherein the first composite is compounded by the waterproof fabric and the first PEVA film that are laminated, with a first hot melt adhesive, and the second composite is compounded by the breathable fabric and the second PEVA film that are laminated, with a second hot melt adhesive; and
stacking the first composite and the second composite such that the first PEVA film is close to the second PEVA film, placing the gel material between the first PEVA film and the second PEVA film, then subjecting a resulting product to heat sealing treatment, bagging the first composite and the second composite to form the connected multiple sealing members, and filling each of the sealing members with the gel material, to obtain the multifunctional gel pad.

9. A method for using the multifunctional gel pad of claim 4 in heat preservation, comprising:
immersing the multifunctional gel pad in water to obtain a hydrogel pad; and
using the hydrogel pad directly; alternatively, heating or cooling the hydrogel pad before using.

10. The method for preparing the gel material of claim 3, wherein the cross-linking agent comprises N,N-methylenebisacrylamide (MBAA);
the water absorbent comprises one or more selected from the group consisting of glycerol and propylene glycol; the reinforcing agent comprises fumed silica;
the photoinitiator comprises one or more selected from the group consisting of a photoinitiator 184 (1-hydroxycyclohexyl phenyl ketone) and a photoinitiator 1173 (2-hydroxy-2-methyl-1-phenyl-1-propanone); and
the cosolvent comprises isopropyl alcohol (IPA).

11. The multifunctional gel pad of claim 4, wherein the cross-linking agent comprises N,N-methylenebisacrylamide (MBAA);
the water absorbent comprises one or more selected from the group consisting of glycerol and propylene glycol; the reinforcing agent comprises fumed silica;
the photoinitiator comprises one or more selected from the group consisting of a photoinitiator 184 (1-hydroxycyclohexyl phenyl ketone) and a photoinitiator 1173 (2-hydroxy-2-methyl-1-phenyl-1-propanone); and
the cosolvent comprises isopropyl alcohol (IPA).

12. The multifunctional gel pad of claim 5, wherein the sealing members each have a regular shape and/or an irregular shape; and each of the sealing members has a lateral dimension and a vertical dimension both less than or equal to 10 cm.

13. The method for preparing the multifunctional gel pad of claim 8, wherein each of the micropores independently has a pore diameter of less than 1 mm, and two adjacent micropores have a separation distance of 4 mm to 6 mm.

14. The method for preparing the multifunctional gel pad of claim 8, wherein the sealing members each have a regular shape and/or an irregular shape; and each of the sealing members has a lateral dimension and a vertical dimension both less than or equal to 10 cm.

15. The method for preparing the multifunctional gel pad of claim 8, wherein the gel material in each of the sealing members has a filling amount of 0.2 g to 1 g.

16. The method for using the multifunctional gel pad of claim 9, wherein each of the micropores independently has a pore diameter of less than 1 mm, and two adjacent micropores have a separation distance of 4 mm to 6 mm.

17. The method for using the multifunctional gel pad of claim 9, wherein the sealing members each have a regular shape and/or an irregular shape; and each of the sealing members has a lateral dimension and a vertical dimension both less than or equal to 10 cm.

18. The method for using the multifunctional gel pad of claim 9, wherein the gel material in each of the sealing members has a filling amount of 0.2 g to 1 g.
